(19) United States
(12) Patent Application Publication
(10) Pub. No.: US 2005/0115243 A1
(43) Pub. Date: Jun. 2, 2005

(54) Flywheel vane combustion engine

(76) Inventor: Donald L. Adle, Farmington Hills, MI (US)

Correspondence Address: Donald L. Adle, 29510 Greenboro, Farmington Hills, MI, 48334, US

(21) Appl. No.: 10/724,499

(22) Filed: Dec. 1, 2003

(51) Int. Cl. F02C 3/055

(52) U.S. Cl. 60/729

(57) ABSTRACT

This Invention relates generally to the free-piston type internal combustion engine, using air by compressing the air, moving the compressed air outward onto the flywheel vane 244, therefor moving the flywheel 240 in a rotary motion. Transferring energy from the flywheel 240 directly to the drive shaft 246. The piston 138 move fore and aft, within the cylinder 112, from the combustion chamber 1 118 to the combustion chamber 2 128. The piston arm 1 148, attached to the piston 138 at one end, the air piston 1 172 at the other end, resulting in the fore and aft movement of the air piston 1 172. The piston arm 2 154, attached to the piston 138 at one end, the air piston 2 178 at the other end, resulting in the fore and aft movement of the air piston 2 178. The air piston 1 172 move fore on the outward stroke and aft on the inward stroke compressing the air, the compressed air is pushing and pulling the flywheel vane 244 in a rotary motion. The air piston 2 178 move fore on the outward stroke and aft on the inward stroke compressing the air, the compressed air is pushing and pulling the flywheel vane 244 in a rotary motion. Using compressed air movement to push and pull the flywheel vane 244, attached to the flywheel 240 in a rotary motion. The flywheel 240, attached to the drive shaft 246, rotating the drive shaft 246.

### CROSS REFERENCE TO RELATED APPLICATIONS

The Dainton device, U.S. Pat. No. 1,802,881 issued April 1931. Internal combustion engine pluralities of stationary cylinders are employed having a common explosive chamber. Pistons in respective cylinders communicate, so that single explosion parts power strokes to several pistons. Rotary motion is transformed from reciprocating motion of the pistons to turn a circular member. Power may be taken off either from periphery thereof or from the center.

The Benoit device, U.S. Pat. No. 3,068,639 issued September 1961.

Free piston internal combustion engine exploded gases are directed to turbine to drive the turbine. Engine comprises two opposed, aligned cylinders having a single piston reciprocally mounted therein. Piston being reciprocated by means of an eccentric cam.

The Benaroya device, U.S. Pat. No. 4,403,577 issued September 1983. Free piston combustion chambers with an air delivery means are formed in the cylinder. Supplying air originating from a compression cylinder associated with the motor cylinder as a jet. Directed along the driving piston, towards the head ring of latter to prevent overheating.

The Heaton device, U.S. Pat. No. 4,449,488 issued May 1984. Free piston internal combustion engine has a pair of interconnected double acting pistons. A pinion gear interconnects double acting pistons. Internally constructed for an inner piston reciprocating within a chamber defined within an outer piston.

The David device, U.S. Pat. No. 4,561,252 issued December 1985. Free piston combustion chamber coupled to air compression and gas expansion chambers, combined with a rotary motor. Two combustion chambers receive compressed air and fuel for combustion outside rotary motor assembly.

The Chaneac device, U.S. Pat. No. 4,848,282 issued July 1989. Combustion engine having no connection rods or crankshaft, whose cylinders are disposed radically. Axes of the cylinders are situated in a plane perpendicular to the drive shaft. Alternating movement of the pistons being transmitted by rollers fixed to said pistons.

The Hammett device, U.S. Pat. No. 4,920,928 issued May 1990. Momentum engine which combustion gas is conducted around a piston for a short time during the expansion stroke.

The Wilson device, U.S. Pat. No. 4,951,618 issued August 1990. Rotary engine construction of radically compact dimension. Cylinders extend in a radial direction and have open outer ends though which piston rods extend. Combination flywheel/ring gear including reinforcing ribs is positioned axially adjacent the cylinders and sheave gears.

The Hanedevic , U.S. Pat. No. 5,678,522 issued October 1997. A magnet, fuel and compressed air hold free piston internal combustion engine, characterized in that piston.

The Bailey device, U.S. Pat. No. 6,205,961 issued March 2001. Free piston internal combustion engine with piston head functioning as a bearing. Piston includes a piston head reciprocally disposed within the combustion cylinder. Second head reciprocally disposed within the second cylinder. Plunger rod rigidly attached to each of and interconnection the pistons head and second head.

The Valentin device, U.S. Pat. No. 6,293,231 issued September 2001. Internal combustion free-piston pump-engine provides pressurized fluid for a hydrostatic power train. Free-piston is reciprocally mounted in a piston bore and transfer combustion pressure directly into pressurized hydraulic fluid.

The Young device, U.S. Pat. No. 6,408,717 issued June 2002. Twin mass flywheels in which first and second flywheel masses. Rotating relative to each other about an axis under control of one or more connection means.

The Nagel device, U.S. Pat. No. 6,449,940 issued September 2002. Internal combustion engine comprises at least one combustion chamber for burning fuel in timed explosions. One expansion combustion connected and separates from the combustion chamber. Its energy drives a shaft that has a cam disk. Cam disk is for carrying out irregular engine cycles independent including a pausing of the piston.

The Morikami device, U.S. Pat. No. 6,450,846 issued September 2002. Flywheel structure of outboard motor has an engine in which a crankshaft is disposed perpendicularly. Flywheel is disposed to upper end portion of the crankshaft. Unison with the crankshaft, flywheel is provoked with a detecting member. Motion which is detected by a sensor means or detecting number of revolution and a revolution angle of the crankshaft.

### CROSS-REFERENCE TO RELATED APPLICATIONS

Not applicable.

### REFERENCE TO MICROFICHE APPENDIX

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING APPENDIX

Not applicable.

### BACKGROUND OF INVENTION

1. This Invention relates generally to the free-piston type internal combustion engine that connected to a flywheel. Particular innovations which improve controllability and efficiency of the free-piston engine combining with a flywheel. Using one cylinder housing, two combustion chambers and one piston. The piston along with two piston arms attached and extended out though an arm opening on each side of the cylinder. One of the piston arm attached to the piston on one side of the piston, other end of the piston arm attached to a air piston. The other piston arm attached to the same piston, on the other side of the same piston and other end of the piston arm attached to a air piston.

2. Invention is directed to an internal combustion engine, which is well known. There are engines with a combustion chamber that are with its piston and rod rigidly attached to the crankshaft. Free-piston engine moves freely and independently of main shaft of the engine. Advantages of a free-piston engine that its piston not being rigidly attached to a crankshaft connected by a rod. Cylinders provide the energy for compression stroke for the pistons.

3. Internal-combustion engine, fuel-air mixture is burned in the engine proper. Hot gaseous products of combustion act directly on the surfaces of its moving parts, such as those of pistons. Using a piston for the hot gaseous in the combustion chamber. By using two air cylinders using air, with each air cylinder housing, a air cylinder chamber, a air piston. The air cylinder chamber with the air piston inside, pushing air outward onto and drawing air inward off the flywheel vane, attached to the flywheel. Therefore rotating the flywheel in a rotary motion. Using a flywheel along with a free moving piston, moving fore and aft from combustion chamber to combustion chamber. This will reduce toxic emissions, weight and size of such engines.

4. Free-piston internal-combustion engines having a cylinder and one or more reciprocation pistons therein. One piston at least of which is movable freely and independently of the main shaft. Engine on the stroke of such piston immediately following ignition of the charge. Burned gases during which stroke the energy is stored. Energy is thereafter transferred to main shaft of the engine. Energy is ordinarily stored by forcing piston against pressure of the atmosphere. Therefor stored energy is ordinarily transferred to the main shaft by securing piston thereto by means of a suitable clutch. Such energy provided with suitable converting mechanism upon its return stroke. This invention there an advantageous application using one cylinder, with two combustion chamber with one piston within freely moving fore and aft, from combustion chamber to combustion chamber.

5. Cylinders provide the energy for compression stroke for the pistons. The cylinder closed at both ends having two combustion chambers house within. Combustion act to move the piston fore and aft from combustion chamber to combustion chamber. Cylinder of an internal-combustion engine is usual closed at one end by a plate called a head and open at the other end. Permitting free oscillation of the connection rod, which joins piston to crankshaft. This Invention relates to the free-piston type internal combustion engine with the cylinder closed at both ends, having two combustion chambers house within. Cylinder closed at both ends using a fre moving piston, being able to move fore and aft from combustion chamber to combustion.

6. Air piston being house within air cylinder. Air piston outward stroke, moves outward toward the flywheel pushing air outward. The air outline door would open within the air outline, during outward stroke, closing on the inward stroke. Out going air pressure pushes on the air outline door, opening air outline door. Incoming air pressure closes the air outline door by air being drawn into air outline. Air outline door remains opened during outward stroke, air outline door stay closed on the inward stroke.

7. Air outline is a pipe for conveying air from the air cylinder chamber, to the flywheel vane. Air outline door house inside the air outline. Control the outflow and inflow of air by using a air outline door. High pressure of air produced within the air cylinder, by the air piston as air is pushed outward though a air outline inlet opening, air is pushed outward into the air outline, than air is pushes outward onto the flywheel vane.

8. Air inline is a pipe for conveying air from the flywheel vane, to the air cylinder chamber. Air inline door house inside the air inline. Control the outflow and inflow of air by using a air inline door. High pressure of air is produced by using the air piston, air is drawn off the flywheel vane, than air drawn inward though a air inline inlet opening, than air inward drawn into a air inline, than air drawn inward though a air inline outlet opening, than air drawn inward into the air cylinder chamber.

9. Flywheel vane usually relatively thin, rigid, flat, or sometimes curved surfaces mounted along an axis, that is driven by the use of air. The air piston and the air cylinder chamber house within the air cylinder. The air piston, pushes air out a air outline inlet opening and air drawn in from a air inline inlet opening. Pushing air outward onto and drawing air inward from the flywheel vane, rotating the flywheel in a rotary motion.

10.Flywheel is a rotation wheel used to minimize variations in angular velocity and revolutions per minute. Flywheel usual corn into play only after crankshaft or other moving parts ends their movements. Flywheel is a wheel attached to a rotating shaft. Smoothing out delivery of power from a motor to a machine. Inertia of the flywheel opposes and moderates fluctuations in speed of engine. Flywheel stores the excess energy for intermittent use. The flywheel smoothes out pulses of energy provided by combustion.

11. A flywheel along with using a free-piston type internal combustion engine in using air, by pushing air outward onto a flywheel vane attached to a flywheel, would initiated, controlled and transmits power to the drive shaft. Using a cylinder, with two combustion chamber with one piston moving fore and aft from combustion chamber to combustion. By using two air cylinders with a air piston in each one. One air piston would be pushing air outward onto the flywheel vane attached to the flywheel, the other air piston would be drawing air off the flywheel vane. This would take advantage of bypassing the use of having a crankshaft rigidly attached to a piston connected by a rod.

12. Simple concept of free-piston internal combustion engines is transferring combustion energy direct into mechanical energy. Flywheels rarely utilized due to its inability to procure energy. Therefore not having control in their operating characteristics particular, free-piston type internal combustion engine and using the flywheel sufficiently. This invention there an advantageous application, using its free-piston type internal combustion engine, by using air to transmit energy onto the flywheel vanes, attached to the flywheel.

### BRIEF SUMMARY OF THE INVENTION

The present invention substantially departs from conventional concepts and designs of prior art. This envention relates generally to the free-piston type internal combustion engine using air by compressing the air, moving the compressed air outward onto and drawing compressed air inward off a flywheel vane 244, pushing and drawing a flywheel 240 in a rotary motion.

A engine 110 comprising in combination, a cylinder 112, a combustion chamber 1 118, a piston 138, a piston arm 1 148, a air cylinder 1 160, a air piston 1 172, a air outline 1 184, a air outline door 1 192, a air inline 1 212, a air inline door 1 220, a combustion chamber 2 128, a piston arm 2 154, a air cylinder 2 166, a air piston 2 178, a air outline 2 198, a air outline door 2 206, a air inline 2 226, a air inline door 2 234, the flywheel 240, the flywheel vane 244, a drive shaft 246.

The cylinder 112 housing, the combustion chamber 1 118, the combustion chamber 2 128, the piston 138. The piston 138 move fore and aft, within the cylinder 112, from the combustion chamber 1 118 to the combustion chamber 2 128. Exploding gases resulting from combustion inside the combustion chamber 1 118 than inside the combustion chamber 2 128, passing from combustion into the expansion means.

The piston 138 moves, the piston arm 1 148 to move fore and aft, within the movements of the piston 138. The piston arm 1 148, attached to the piston 138, within the cylinder 112, and extended though a arm opening 1 114. The piston arm 1 148, attached to one side of the piston 138, the piston arm 2 154 attached to the other side. The other end of the piston arm 1 148, attached to the air piston 1 172.

The air cylinder 1 160 housing, the air piston 1 172. The piston arm 1 148 moves, the air piston 1 172 to move fore and aft, within the movements of the piston 138.

The air piston 1 172, compressing the outgoing air on the outward stroke though a air outline inlet 1 186, than outward air enters the air outline 1 184. The air outline 1 184, outward air enters a air outline outlet 1 188, then air outward onto the flywheel vane 244. The air piston 1 172 move for on th outward stroke and aft on th inward stroke compressing the air, the compressed air is pushing and pulling the flywheel vane 244 in a rotary motion.

The air piston 1 172 moves inward, away from the flywheel 240, pulling and drawing compressed air inward into a air inline inlet 1 214. The air piston 1 172, compressing the incoming air on the inward stroke though the air inline inlet 1 214, air moves inward though the air inline 1 212, air moves inward though a air inline outlet 1 216, drawing the air inward into a air cylinder chamber 1 162. Inward air movement of the compressed air drawn and pulls the flywheel 240 in a rotary motion.

The air outline door 1 192 used as closed, stopping air coming in or used as open, letting air out the air outline 1 184.

The air inline door 1 220 used as closed, stopping air coming in or used as open, letting air out the air inline 1 212.

The piston 138 moves, the piston arm 2 154 to move fore and aft, within the movements of the piston 138. The piston arm 2 154, attached to the piston 138, within the cylinder 112, and extended though a arm opening 2 116. The piston arm 2 154, attached to one side of the piston 138, the piston arm 1 148 attached to the other side. The other end of the piston arm 2 154, attached to the air piston 2 178.

The air cylinder 2 166 housing, the air piston 2 178. The piston arm 2 154 moves, the air piston 2 178 to move fore and aft, within the movements of the piston 138.

The air piston 2 178, compressing the outgoing air on the outward stroke though a air outline inlet 2 200, than outward air enters the air outline 2 198. The air outline 2 198, outward air enters a air outline outlet 2 202, then air outward onto the flywheel vane 244. The air piston 2 178 move fore on the outward stroke and aft on the inward stroke compressing the air, the compressed air is pushing and pulling the flywheel vane 244 in a rotary motion.

The air piston 2 178 moves inward, away from the flywheel 240, pulling and drawing compressed air inward into a air inline inlet 2 228. The air piston 2 178, compressing the incoming air on the inward strok though the air inline inlet 2 228, air moves inward though the air inline 2 226, air moves inward though a air inline outlet 2 230, drawing the air inward into a air cylinder chamber 2 168. Inward air movement of the compressed air drawn and pulls the flywheel 240 in a rotary motion.

The air outline door 2 206 used as closed, stopping air coming in or used as open, Letting air out the air outline 2 198.

The air inline door 2 234 used as closed, stopping air coming in or used as open, letting air out the air inline 2 226.

Using compressed air movement to push air onto, on the outward stroke and air drawn in from on the inward stroke, to and from the flywheel vane 244, moving the flywheel 240 attached in a rotary motion. The flywheel 240, attached to the drive shaft 246, rotating the drive shaft 246 in a rotary motion, converting energy into mechanical energy or work.

### DETAILED DESCRIPTION OF THE INVENTION

According present description the cylinder 112, used for the fore and aft movement of the piston 138. The piston 138 move fore and aft, within the cylinder 112, from the combustion chamber 1 118 to the combustion chamber 2 128.

The combustion chamber 1 118, used for exploding combustion gases, moving the piston 138. A piston side 1 144, of the piston 138, pushed by the exploding combustion gases within the combustion chamber 1 118, moves toward the combustion chamber 2 128.

The combustion chamber 2 128, used for exploding combustion gases, moving the piston 138. A piston side 2 146, of the piston 138, pushed by the exploding combustion gases within the combustion chamber 2 128, moves toward the combustion chamber 1 118.

The piston 138, used for the movement of the piston arm 1 148. The piston arm 1 148, attached to the piston 138 at one end, the air piston 1 172 at the other end, resulting in the fore and aft movement of the air piston 1 172.

The piston 138, used for the movement of the piston arm 2 154. The piston arm 2 154, attached to the piston 138 at one end, the air piston 2 178 at the other end, resulting in the fore and aft movement of the air piston 2 178.

The piston arm 1 148, used for the movement of the air piston 1 172 to move fore and aft within the movement of the piston 138.

The piston arm 2 154, used for the movement of the air piston 2 178 to move fore and aft within the movement of the piston 138.

The air cylinder 1 160, used for the fore and aft movement of the air piston 1 172. The air cylinder chamber 1 162, within the air cylinder 1 160, used for a air piston side 1 176, of the air piston 1 172.

The air cylinder 2 166, used for the fore and aft movement of the air piston 2 178. The air cylinder chamber 2 168, within the air cylinder 2 166, used for a air piston side 2 182, of the air piston 2 178.

The air piston 1 172, used for the fore on the outward stroke and aft on the inward stroke movement for compressing the air.

The air piston 2 178, used for the fore on the outward stroke and aft on the inward stroke movement for compressing the air.

The air outline 1 184, used for movement of outward air from the air cylinder chamber 1 162, air outward onto the flywheel vane 244.

The air outline door 1 192 as open, used for letting movement of air though the air outline 1 184.

The air outline door 1 192 as closed, used for stopping movement of air though the air outline 1 184.

The air outline 2 198, used for movement of air outward from the air cylinder chamber 2 168, air outward onto the flywheel van 244.

The air outline door 2 206 as open, used for letting movement of air though the air outline 2 198.

The air outline door 2 206 as closed, used for stopping movement of air though the air outline 2 198.

The air inline 1 212, used movement of air inward from the flywheel vane 244, air drawn into the air cylinder chamber 1 162.

The air inline door 1 220 as open, used for letting movement of air though the air inline 1 212.

The air inline door 1 220 as closed, used for stopping movement of air though the air inline 1 212.

The air inline 2 226, used movement of air inward from the flywheel vane 244, air drawn into the air cylinder chamber 2 168.

The air inline door 2 234 as open, used for letting movement of air though the air inline 2 226.

The air inline door 2 234 as closed, used for stopping movement of air though the air inline 2 226.

The flywheel 240, used to attached the flywheel vane 244 onto. The flywheel vane 244 used for the compressed air to push and pull the flywheel 240 in a rotary motion. The flywheel 240, attached to the drive shaft 246, rotating the drive shaft 246.

The drive shaft 246, attached to the flywheel 240, used for converting energy into mechanical energy or work.

### Engine 110

Objects retained by external combustion, the engine 110 utilizing member including
the cylinder 112,
the combustion chamber 1 118,
the combustion chamber 2 128,
the piston 138,
the air cylinder 1 160,
th air cylinder 2 166,
the air piston 1 172,
the air piston 2 178,
the air outline 1 184,
the air outline 2 198,
the air inline 1 212,
the air inline 2 226,
the flywheel 240,
the drive shaft 246.

The engine 110 converts energy into mechanical force. The cylinder 112 closed at both ends, with the combustion chamber 1 118 and the combustion chamber 2 128 house within.

The cylinder 112 housing, the combustion chamber 1 118, the combustion chamber 2 128, the piston 138. The cylinder 112 closed at both ends, with the combustion chamber 1 118 and the combustion chamber 2 128 house within.

The combustion chamber 1 118 has, a sensor 1 120, a injector 1 122, a spark plug 1 124, a exhaust outlet 1 126. The sensor 1 120, measuring to determine the fuel pumping through the injector 1 122. The injector 1 122 admitting air-fuel inside.

The spark plug 1 124, delivering a spark igniting the mix within the combustion chamber 1 118. Air-fuel inside the combustion chamber 1 118 explodes. The exhaust enters the exhaust outlet 1 126, exhaust from the combustion chamber 1 118, exhaust leaving the engine 110. Exploding gases resulting from combustion inside the combustion chamber 1 118, passed from combustion means into the expansion means. The piston side 1 144, of the piston 138, pushed by the exploding combustion gases within the combustion chamber 1 118, moves toward the combustion chamber 2 128. Exploding gases resulting in the fore and aft movement of the piston 138, within-the cylinder 112.

The combustion chamber 2 128 has, a sensor 2 130, a injector 2 132, a spark plug 2 134, a exhaust outlet 2 136. The sensor 2 130, measuring to determine the fuel pumping through the injector 2 132. The injector 2 132 admitting air-fuel inside.

The spark plug 2 134, delivering a spark igniting the mix within the combustion chamber 2 128. Air-fuel inside the combustion chamber 2 128 explodes. The exhaust enters the exhaust outlet 2 136, exhaust from the combustion chamber 2 128, exhaust leaving the engine 110. Exploding gases resulting from combustion inside the combustion chamber 2 128, passed from combustion means into the expansion means. The piston side 2 146, of the piston 138, pushed by the exploding combustion gases within the combustion chamber 2 128, moves toward the combustion chamber 1 118. Exploding gases resulting in the fore and aft movement of the piston 138, within the cylinder 112.

The piston 138 has, a piston ring 1 140, a piston ring 2 142, the piston arm 1 148, the piston arm 2 154, the air piston 1 172, the air piston 2 178.

The piston 138 move fore and aft, within the cylinder 112, from the combustion chamber 1 118 to the combustion chamber 2 128.

The piston ring 1 140, fitting around the piston 138, stopping combustion gases movement from leaving the combustion chamber 1 118, around the piston 138.

The piston ring 2 142, fitting around the piston 138, stopping combustion gases movement from leaving the combustion chamber 2 128, around the piston 138.

The piston 138, moves the piston arm 1 148, the air piston 1 172, within the movement of the piston 138.

The piston arm 1 148, attached to the piston 138, movement though the arm opening 1 114, opening in the cylinder 112.

The arm opening 1 114, opening in the cylinder 112, used for movement of the piston arm 1 148, attached to the piston 138.

The piston arm 1 148, attached to the piston 138 at one end, the air piston 1 172 at the other end.

The piston 138, moves the piston arm 2 154, the air piston 2 178, within the movement of the piston 138.

The piston arm 2 154, attached to the piston 138, movement though the arm opening 2 116, opening in the cylinder 112.

The arm opening 2 116, opening in the cylinder 112, used for movement of the piston arm 2 154, attached to the piston 138.

The piston arm 2 154, attached to the piston 138 at one end, the air piston 2 178 at the other end.

The air cylinder 1 160 housing, the air cylinder chamber 1 162, the air piston 1 172, a air piston ring 1 174. The air cylinder 1 160 has, a air cylinder opening 1 164, the air outline inlet 1 186, the air inline outlet 1 216.

The air cylinder 2 166 housing, the air cylinder chamber 2 168, the air piston 2 178, a air piston ring 2 180. The air cylinder 2 166 has, a air cylinder opening 2 170, the air outline inlet 2 200, the air inline outlet 2 230.

The air cylinder opening 1 164, opening in the air cylinder 1 160. The air cylinder opening 1 164, used for movement of the piston arm 1 148, attached to the air piston 1 172.

The piston arm 1 148, attached to the air piston 1 172.

The air cylinder opening 2 170, opening in the air cylinder 2 166. The air cylinder opening 2 170, used for movement of the piston arm 2 154, attached to the air piston 2 178.

The piston arm 2 154, attached to the air piston 2 178. The air cylinder chamber 1 162,-used for the fore and aft movement of the air piston 1 172.

The air cylinder chamber 2 168, used for the fore and aft movement of the air piston 2 178.

The air piston 1 172 has, the piston arm 1 148, the air piston ring 1 174.

The air piston 2 178 has, the piston arm 2 154, the air piston ring 2 180.

The air piston ring 1 174, fitting around the air piston 1 172, stopping air movement from leaving the air cylinder 1 160, around the air piston 1 172.

The air piston ring 2 180, fitting around the air piston 2 178, stopping air movement from leaving the air cylinder 2 166, around the air piston 2 178.

The air piston 1 172 moves outward, toward the flywheel 240, compressing outgoing air, pushing the air movement outward into the air outline inlet 1 186. Th air outline 1 184, outward air enters the air outline outlet 1 188.

The air piston 2 178 moves outward, toward the flywheel 240, compressing outgoing air, pushing the air movement outward into the air outline inlet 2 200. The air outline 2 198, outward air enters the air outline outlet 2 202.

The air piston 1 172 moves inward, away from the flywheel 240, pulling and drawing compressed air into the air inline inlet 1 214. The air inline 1 212, air drawn into the air inline outlet 1 216, then air drawn into the air cylinder 1 160.

The air piston 2 178 moves inward, away from the flywheel 240, pulling and drawing compressed air into the air inline inlet 2 228. The air inline 2 226, air drawn into the air inline outlet 2 230, then air drawn into the air cylinder 2 166.

The air outline 1 184 housing, a air outline chamber 1 190, the air outline door 1 192, a air outline hinge 1 194, a air outline door vane 1 196. The air outline 1 184 has, the air outline inlet 1 186, the air outline outlet 1 188.

The air outline 2 198 housing, a air outline chamber 2 204, the air outline door 2 206, a air outline hinge 2 208, a air outline door vane 2 210. The air outline 2 198 has, the air outline inlet 2 200, the air outline outlet 2 202.

The air outline chamber 1 190, a open area used for opening and closing, the air outline door 1 192.

The air outline chamber 2 204, a open area used for opening and closing, the air outline door 2 206.

The air outline door 1 192 has, the air outline hinge 1 194, the air outline door vane 1 196.

The air outline door 2 206 has, the air outline hinge 2 208, the air outline door vane 2 210.

The air outline door 1 192 as closed, used for stopping air movement in the air outline 1 184. The air outline door 1 192 as open, used for letting air movement though the air outline 1 184.

The air outline door 2 206 as closed, used for stopping air movement in the air outline 2 198. The air outline door 2 206 as open, used for letting air movement though the air outline 2 198.

The air outline door vane 1 196, used for air movement inward moving onto and closing the air outline door 1 192.

The air outline door vane 2 210, used for air movement inward moving onto and closing the air outline door 2 206.

The air outline hinge 1 194, used for attaching the air outline door 1 192, onto the air outline 1 184.

The air outline hinge 2 208, used for attaching the air outline door 2 206, onto the air outline 2 198.

The air inline 1 212 housing, a air inline chamber 1 218, the air inline door 1 220, a air inline hinge 1 222, a air inline door vane 1 224. The air inline 1 212 has, the air inline inlet 1 214, the air inline outlet 1 216.

The air inline 2 226 housing, a air inline chamber 2 232, the air inline door 2 234, a air inline hinge 2 236, a air inline door vane 2 238. The air inline 2 226 has, the air inline inlet 2 228, the air inline outlet 2 230.

The air inline chamber 1 218, a open area used for opening and closing, the air inline door 1 220.

The air inline chamber 2 232, a open area used for opening and closing, the air inline door 2 234.

The air inline door 1 220 has, the air inline hinge 1 222, the air inline door vane 1 224.

The air inline door 2 234 has, the air inline hinge 2 236, the air inline door vane 2 238.

The air inline door 1 220 as closed, used for stopping air movement in the air inline 1 212. The air inline door 1 220 as open, used for letting air movement though the air inline 1 212.

The air inline door 2 234 as closed, used for stopping air movement in the air inline 2 226. The air inline door 2 234 as open, used for letting air movement though the air inline 2 226.

The air inline door van 1 224, used for air movement moving outward onto and closing the air inline door 1 220.

The air inline door vane 2 238, used for air movement moving outward onto and closing the air inline door 2 234.

The air inline hinge 1 222, used for attaching the air inline door 1 220, onto the air inline 1 212.

The air inline hinge 2 236, used for attaching the air inline door 2 234, onto the air inline 2 226.

The flywheel vane 244, air is drawn into the air inline inlet 1 214, then air drawn into the air inline 1 212, drawing the flywheel vane 244 in a rotary motion. Air from the air inline 1 212, air drawn into the air inline outlet 1 216, then air drawn into the air cylinder 1 160.

The flywheel vane 244, air is drawn into the air inline inlet 2 228, then air drawn into the air inline 2 226, drawing the flywheel vane 244 in a rotary motion Air from the air inline 2 226, air drawn into the air inline outlet 2 230, then air drawn into the air cylinder 2 166.

The flywheel 240 has attached, the flywheel vane 244, the drive shaft 246. The flywheel vane 244, attached to the flywheel 240 The rotary motion of the flywheel vane 244, attached to the flywheel 240, used for the rotary motion of the drive shaft 246.

The drive shaft 246, driven from the continuous rotation of the flywheel 240. The drive shaft 246, converting energy into mechanical energy or work.

### Cylinder 112

The cylinder 112 utilizing member including
the arm opening 1 114,
the arm opening 2 116.

The cylinder 112 housing, the combustion chamber 1 118, the combustion chamber 2 128, the piston 138. The cylinder 112 closed at both ends, with the combustion chamber 1 118 and the combustion chamber 2 128 house within.

The cylinder 112, used for the for and aft movement of the piston 138. The combustion chamber 1 118, used for exploding combustion gases, moving the piston 138. The exploding gases inside the combustion chamber 1 118 resulting in the movement of pushing the piston 138, toward the combustion chamber 2 128. The combustion chamber 2 128, used for exploding combustion gases, moving the piston 138. The exploding gases inside the combustion chamber 2 128 resulting in the movement of pushing the piston 138, toward the combustion chamber 1 118.

The combustion chamber 1 118, has, the sensor 1 120, the injector 1 122, the spark plug 1 124, the exhaust outlet 1 126. The sensor 1 120, used for measuring the inwardness of the piston 138, to determine the point for fuel pumping through the injector 1 122. The injector 1 122, used for fuel pumping into the combustion chamber 1 118. The spark plug 1 124, used for delivering a spark igniting the mix within the combustion chamber 1 118. The exhaust outlet 1 126, used for exhaust to leave the combustion chamber 1 118, exhaust leaving the engine 110.

The combustion chamber 2 128, has, the sensor,2 130, the injector 2 132, the spark plug 2 134, the exhaust outlet 2 136. The sensor 2 130, used for measuring the inwardness of the piston 138, to determine the point for fuel pumping through the injector 2 132. The injector 2 132, used for fuel pumping into the combustion chamber 2 128. The spark plug 2 134, used for delivering a spark igniting the mix within the combustion chamber 2 128. The exhaust outlet 2 136, used for exhaust to leave the combustion chamber 2 128, exhaust leaving the engine 110.

The cylinder 112, used for the movement of the piston 138, to move fore and aft, from the combustion chamber 1 118 to the combustion chamber 2 128. The piston side 1 144, of the piston 138, pushed by the exploding combustion gases within the combustion chamber 1 118, moves toward the combustion chamber 2 128.

The piston ring 1 140, fitting near the combustion chamber 1 118, around the piston 138. The piston ring 1 140, fitting around the piston 138, stopping combustion gases movement from leaving the combustion chamber 1 118, around the piston 138.

The piston arm 1 148, attached to the piston 138. A piston side attached 1 150, attaching the piston 138, the piston arm 1 148 together. The piston arm 1 148 and the air piston 1 172, moves within the movement of the piston 138.

The cylinder 112 has, the arm opening 1 114. The arm opening 1 114, used for movement of the piston arm 1 148, attached to the piston 138. The arm opening 1 114, opening on one side of the cylinder 112, the arm opening 2 116, opening opposite side, of the cylinder 112. The piston arm 1 148, attached to the piston 138, and extended though the arm opening 1 114. The arm opening 1 114, used for movement of the piston arm 1 148, to move fore and aft, within movements of the piston 138.

The cylinder 112, used for the movement of the piston 138, to move fore and aft, from the combustion chamber 2 128 to the combustion chamber 1 118. The piston side 2 146, of the piston 138, pushed by the exploding combustion gases within the combustion chamber 2 128, moves toward the combustion chamber 1 118.

The piston ring 2 142, fitting near the combustion chamber 2 128, around the piston 138. The piston ring 2 142, fitting around the piston 138, stopping combustion gases movement from leaving the combustion chamber 2 128, around the piston 138.

The piston arm 2 154, attached to the piston 138. A piston side attached 2 156, attaching the piston 138, the piston arm 2 154 together. The piston arm 2 154 and the air piston 2 178, moves within the movement of the piston 138.

The cylinder 112 has, the arm opening 2 116. The arm opening 2 116, used for movement of the piston arm 2 154, attached to the piston 138. The arm opening 2 116, opening on one side of the cylinder 112, the arm opening 1 114, opening opposite side, of the cylinder 112. The piston arm 2 154, attached to the piston 138, and extended though the arm opening 2 116. The arm opening 2 116, used for movement of the piston arm 2 154, to move fore and aft, within movements of the piston 138.

### Combustion Chamber 1 118

The combustion chamber 1 118 utilizing member including
the sensor 1 120,
the injector 1 122,
the spark plug 1 124,
the exhaust outlet 1 126.

The combustion chamber 1 118 has, the sensor 1 120, the injector 1 122, the spark plug 1 124, the exhaust outlet 1 126. The combustion chamber 1 118, house within the cylinder 112. The cylinder 112 closed at both ends having the combustion chamber 1 118 at one end, the combustion chamber 2 128 at the other end.

The combustion chamber 1 118 enclosure in which combustion with a fuel or propellant is initiated and controlled. The combustion chamber 1 118, used for exploding combustion gases, moving the piston 138. The exploding gases inside the combustion chamber 1 118 resulting in the movement of pushing the piston 138, toward the combustion chamber 2 128. The piston side 1 144, of the piston 138, pushed by the exploding combustion gases within the combustion chamber 1 118, moves toward the combustion chamber 2 128. The exploding gases inside the combustion chamber 2 128 resulting in the movement of pushing the piston 138, toward the combustion chamber 1 118. The piston side 2 146, of the piston 138, pushed by the exploding combustion gases within the combustion chamber 2 128, moves toward the combustion chamber 1 118. The piston 138 move fore and aft, from the combustion chamber 1 118, to the combustion chamber 2 128.

The sensor 1 120, inserted into side of the combustion chamber 1 118. The sensor 1 120, measuring the inwardness of the piston 138, to determine the point for amount of and fuel pumping through the injector 1 122.

The injector 1 122, inserted into side of the combustion chamber 1 118. The injector 1 122 and the electrical fuel pumping means not shown receives a signal from the sensor 1 120. The injector 1 122, receives a signal from the sensor I 120, the point used for amount and fuel pumping through the injector 1 122. The injector 1 122, admitting air-fuel inside the combustion chamber 1 118.

The spark plug 1 124, inserted into side of the combustion chamber 1 118. The spark plug 1 124, receives a signal from the sensor 1 120. The spark plug 1 124, delivering a spark igniting the mix within the combustion chamber 1 118. Air-fuel inside the combustion chamber 1 118 explodes.

The exhaust outlet 1 126, opening in the combustion chamber 1 118. The exhaust enters the exhaust outlet 1 126, exhaust from the combustion chamber 1 118, exhaust leaving the engine 110.

### Combustion Chamber 2 128

The combustion chamber 2 128 utilizing member including
the sensor 2 130,
the injector 2 132,
the spark plug 2 134,
the exhaust outlet 2 136.

The combustion chamber 2 128 has, the sensor 2 130, the injector 2 132, the spark plug 2 134, the exhaust outlet 2 136. The combustion chamber 2 128, house within the cylinder 112. The cylinder 112 closed at both ends having the combustion chamber 2 128 at one end, the combustion chamber 1 118 at the other end.

The combustion chamber 2 128 enclosure in which combustion with a fuel or propellant is initiated and controlled. The combustion chamber 2 128, used for exploding combustion gases, moving the piston 138. The exploding gases inside the combustion chamber 2 128 resulting in the movement of pushing th piston 138, toward the combustion chamber 1 118. The piston side 2 146, of the piston 138, pushed by the exploding combustion gases within the combustion chamber 2 128, moves toward the combustion chamber 1 118. The exploding gases inside the combustion chamber 1 118 resulting in the movement of pushing the piston 138, toward the combustion chamber 2 128. The piston side 1 144, of the piston 138, pushed by the exploding combustion gases within the combustion chamber 1 118, moves toward the combustion chamber 2 128. The piston 138 move fore and aft, from the combustion chamber 2 128, to the combustion chamber 1 118.

The sensor 2 130, inserted into side of the combustion chamber 2 128. The sensor 2 130, measuring the inwardness of the piston 138, to determine the point for amount of and fuel pumping through the injector 2 132.

The injector 2 132, inserted into side of the combustion chamber 2 128. The injector 2 132 and the electrical fuel pumping means not shown receives a signal from the sensor 2 130. The injector 2 132, receives a signal from the sensor 2 130, the point used for amount and fuel pumping through the injector 2 132. The injector 2 132, admitting air-fuel inside the combustion chamber 2 128.

The spark plug 2 134, inserted into side of the combustion chamber 2 128. The spark plug 2 134, receives a signal from the sensor 2 130. The spark plug 2 134, delivering a spark igniting the mix within the combustion chamber 2 128. Air-fuel inside the combustion chamber 2 128 explodes.

The exhaust outlet 2 136, opening in the combustion chamber 2 128. The exhaust enters the exhaust outlet 2 136, exhaust from the combustion chamber 2 128, exhaust leaving the engine 110.

### Piston 138

The piston 138, utilizing member including
the piston ring 1 140,
the piston ring 2 142,
the piston side 1 144,
the piston side 2 146,
the piston arm 1 148,
the piston arm 2 154.

The piston 138, house within the cylinder 112. The piston 138 move fore and aft, from the combustion chamber 1 118 to the combustion chamber 2 128. The cylinder 112 closed at both ends, with the combustion chamber 1 118 and the combustion chamber 2 128 house within.

The piston 138, used for the movement of the piston arm 2 154 and the air piston 2 178, to move fore and aft within the movement of the piston 138. The piston arm 2 154 and the air piston 2 178, moves within the movement of the piston 138. The piston 138 has, the piston ring 1 140, the piston ring 2 142, the piston side 1 144, the piston side 2 146, the piston arm 1 148, the piston arm 2 154.

The piston ring 1 140, fitting near the piston side 1 144, around the piston 138. The piston ring 1 140, fitting around the piston 138, stopping combustion gases movement from leaving the combustion chamber 1 118, around the piston 138.

The piston ring 2.142, fitting near the piston side 2 146, around the piston 138. The piston ring 2 142, fitting around the piston 138, stopping combustion gases movement from leaving the combustion chamber 2 128, around the piston 138.

The exploding gases inside the combustion chamber 1 118 resulting in the movement of pushing the piston 138, toward the combustion chamber 2 128. The piston side 1 144, of the piston 138, pushed by the exploding combustion gases within the combustion chamber 1 118, moves toward the combustion chamber 2 128. The piston 138 move fore and aft, from the combustion chamber 1 118, to the combustion chamber 2 128.

The exploding gases inside the combustion chamber 2 128 resulting in the movement of pushing the piston 138, toward the combustion chamber 1 118. The piston side 2 146, of the piston 138, pushed by the exploding combustion gases within the combustion chamber 2 128, moves toward the combustion chamber 1 118. The piston 138 move fore and aft, from the combustion chamber 2 128, to the combustion chamber 1 118.

The piston 138, moves the piston arm 1 148 and the air piston 1 172, within the movement of the piston 138. The piston arm 1 148, attached to the piston 138 at one end, attached to the air piston 1 172 at the other end. The piston arm 1 148, attached to the piston 138 at one end, the air piston 1 172 at the other end, resulting in the fore and aft movement of the air piston 1 172. The piston arm 1 148, attached to the piston 138, movement though the arm opening 1 114, opening in the cylinder 112.

The piston 138, moves the piston arm 2 154 and the air piston 2 178, within the movement of the piston 138. The piston arm 2 154, attached to the piston 138 at one end, attached to the air piston 2 178 at the other end. The piston arm 2 154, attached to the piston 138 at one end, the air piston 2 178 at the other end, resulting in the fore and aft movement of the air piston 2 178. The piston arm 2 154, attached to the piston 138, movement though the arm opening 2 116, opening in the cylinder 112.

The piston 138 attached to, the piston arm 1 148 attached to, the air piston 1 172 compressing the outgoing air on the outward stroke, though the air outline inlet 1 186. The air piston 1 172, within the air cylinder 1 160, pushes air movement outward into the air outline inlet 1 186, air movement outward than enters the air outline 1 184.

The air piston 1 172, compressing the incoming air on the inward stroke. Air moves inward though the air inline 1 212, air moves inward though the air inline outlet 1 216, drawing the air inward into the air cylinder chamber 1 162.

The piston 138 attached to, the piston arm 1 148 attached to, the air piston 2 178 compressing the outgoing air on the outward stroke though, the outline inlet 2 200. The air piston 2 178, within the air cylinder 2 166, pushes air movement outward into the air outline inlet 2 200, air movement outward than enters the air outline 2 198.

The air piston 2 178, compressing the incoming air on the inward stroke. Air moves inward though the air inline 2 226, air moves inward though the air inline outlet 2 230, drawing the inward air into the air cylinder chamber 2 168.

### Piston Arm 1 148

The piston arm 1 148, utilizing member including
the piston side attached 1 150,
a air piston attached 1 152.

The piston arm 1 148 has, the piston 138, the piston side attached 1 150, the air piston 1 172, the air piston attached 1 152. The piston arm 1 148, used for the movement of the air piston 1 172 to move fore and aft within the movement of the piston 138. The piston arm 1 148 and the air piston 1 172, moves within the movement of the piston 138.

The piston arm 1 148, attached to the piston 138 at one end, attached to the air piston 1 172 at the other end. The piston side attached 1 150, attaching the piston 138, the piston arm 1 148 together. The air piston attached 1 152, attaching the piston arm 1 148, the air piston 1 172 together.

The piston 138, attached to the piston arm 1 148, resulting in the fore and aft movement of the piston arm 1 148. The piston arm 1 148, attached to the piston 138 at one end, the air piston 1 172 at the other end, resulting in the fore and aft movement of the air piston 1 172.

The arm opening 1 114, opening on one side of the cylinder 112, the arm opening 2 116, opening opposite side, of the cylinder 112. The arm opening 1 114, used for movement of the piston arm 1 148, to move fore and aft, within movements of the piston 138. The piston arm 1 148, attached to the piston 138, and extended though the arm opening 1 114. The piston arm 1 148, attached to the piston 138, movement though the arm opening 1 114, opening in the cylinder 112.

### Piston Arm 2 154

The piston arm 2 154, utilizing member including
the piston side attached 2 156,
a air piston attached 2 158.

The piston arm 2 154 has, the piston 138, the piston side attached 2 156, the air piston 2 178, the air piston attached 2 158. The piston arm 2 154, used for the movement of the air piston 2 178 to move fore and aft within the movement of the piston 138. The piston arm 2 154 and the air piston 2 178, moves within the movement of the piston 138.

The piston arm 2 154, attached to the piston 138 at one end, attached to the air piston 2 178 at the other end. The piston side attached 2 156, attaching the piston 138, the piston arm 2 154 together. The air piston attached 2 158, attaching the piston arm 2 154, the air piston 2 178 together.

The piston 138, attached to the piston arm 2 154, resulting in the fore and aft movement of the piston arm 2 154. The piston arm 2 154, attached to the piston 138 at one end, the air piston 2 178 at the other end, resulting in the fore and aft movement of the air piston 2 178.

The arm opening 2 116, opening on one side of the cylinder 112, the arm opening 1 114, opening opposite side, of the cylinder 112. The arm opening 2 116, used for movement of the piston arm 2 154, to move fore and aft, within movements of the piston 138. The piston arm 2 154, attached to the piston 138, and extended though the arm opening 2 116. The piston arm 2 154, attached to the piston 138, movement though the arm opening 2 116, opening in the cylinder 112.

### Air Cylinder 1 160

The air cylinder 1 160, utilizing member including
the air cylinder chamber 1 162,
the air cylinder opening 1 164,

The air cylinder 1 160 housing, the air cylinder chamber 1 162. The air cylinder 1 160 has, the air cylinder opening 1 164, the air outline inlet 1 186, the air inline outlet 1 216, the piston arm 1 148, the air piston 1 172, the air piston ring 1 174.

The air cylinder 1 160, used for the fore and aft movement of the air piston 1 172. The air cylinder chamber 1 162, used for fore and aft movement of air by the air piston 1 172. The air cylinder 1 160, used for outward stroke of the air piston 1 172, pushing air out of the air cylinder chamber 1 162, air outward into the air outline inlet 1 186. The air cylinder 1 160, used for inward stroke of the air piston 1 172, drawing air in from the air inline outlet 1 216, air inward into the air cylinder chamber 1 162.

The air cylinder opening 1 164, opening in the air cylinder 1 160. The air cylinder opening 1 164, used for movement of the piston arm 1 148, attached to the air piston 1 172. The piston side attached 1 150, attaching the piston 138, the piston arm 1 148 together. The air piston attached 1 152, attaching the piston arm 1 148, the air piston 1 172 together.

The piston arm 1 148, attached to the piston 138 at one end, attached to the air piston 1 172 at the other end.

The piston 138, attached to the piston arm 1 148, for the piston arm 1 148 to move fore and aft in the movement of the piston 138. The piston arm 1 148, attached to the air piston 1 172, to move fore and aft in the movement of the piston arm 1 148.

The air cylinder chamber 1 162, within the air cylinder 1 160. The air cylinder chamber 1 162, used for the fore and aft movement of the air piston 1 172, within the air,cylinder 1 160. Air movement, resulting from fore and aft movement of the air piston 1 172.

The air piston 1 172, on the outward stroke move toward the flywheel vane 244, attached to the flywheel 240. The air cylinder 1 160, air movement outward pushed into the air outlin inlet 1 186, by using the air piston 1 172, air movement outward than enters the air outlin 1 184. The air outline 1 184 air, as the air piston 1 172, moves outward toward the flywheel 240, compressing outgoing air, pushing the air movement outward into the air outline inlet 1 186, than air outward into the air outline 1 184, air outward onto the flywheel vane 244.

The air piston 1 172 on the inward stroke, move away from the flywheel vane 244, attached to the flywheel 240. The air cylinder 1 160, draws air movement inward, by using the air piston 1 172, drawing air inward into the air inline inlet 1 214, than air inward-into the air inline 1 212, than air inward into the air inline outlet 1 216, then air inward into the air cylinder 1 160.

The air piston ring 1 174, fitting around the air piston 1 172, within the air cylinder 1 160. The air piston ring 1 174, fitting around the air piston 1 172, stopping air movement from leaving the air cylinder chamber 1 162, around the air piston 1 172.

### Air Cylinder 2 166

The air cylinder 2 166, utilizing member including
the air cylinder chamber 2 168,
the air cylinder opening 2 170.

The air cylinder 2 166 housing, the air cylinder chamber 2 168. The air cylinder 2 166 has, the air cylinder opening 2 170, the air outline inlet 2 200, the air inline outlet 2 230, the piston arm 2 154, the air piston 2 178, the air piston ring 2 180.

The air cylinder 2 166, used for the fore and aft movement of the air piston 2 178. The air piston chamber 2 168, used for fore and aft movement of air by the air piston 2 178. The air cylinder 2 166, used for outward stroke of the air piston 2 178, pushing air out of the air cylinder chamber 2 16e, air outward into the air outline inlet 2 200. The air cylinder 2 166, used for inward stroke of the air piston 2 178, drawing air in from the air inline outlet 2 230, air inward into the air cylinder chamber 2 168.

The air cylinder opening 2 170, opening in the air cylinder 2 166. The air cylinder opening 2 170, used for movement of the piston arm 2 154, attached to the air piston 2 178.

The piston side attached 2 156, attaching the piston 138, the piston arm 2 154 together. The air piston attached 2 158, attaching the piston arm 2 154, the air piston 2 178 together.

The piston arm 2 154, attached to the piston 138 at one end, attached to the air piston 2 178 at the other end.

The piston 138, attached to the piston arm 2 154, for the piston arm 2 154 to move fore and aft in the movement of the piston 138. The piston arm 2 154, attached to the air piston 2 178, to move fore and aft in the movement of the piston arm 2 154.

The air cylinder chamber 2 168, within the air cylinder 2 166. The air cylinder chamber 2 168, used for the fore and aft movement of the air piston 2 178, within the air cylinder 2 166. Air movement, resulting from fore and aft movement of the air piston 2 178.

The air piston 2 178, on the outward stroke move toward the flywheel vane 244, attached to the flywheel 240. The air cylinder 2 166, air movement outward pushed into the air outline inlet 2 200, by using the air piston 2 178, air movement outward than enters the air outline 2 198. The air outline 2 198 air, as the air piston 2 178, moves outward toward the flywheel 240, compressing outgoing air, pushing the air movement outward into the air outline inlet 2 200, than air outward into the air outline 2 198, air outward onto the flywheel vane 244.

The air piston 2 178, on the inward stroke move away from the flywheel vane 244, attached to the flywheel 240. The air cylinder 2 166, draws air movement inward, by using the air piston 2 178, drawing air inward into the air inline inlet 2 228, than air inward into the air inline 2 226, than air inward into the air inline outlet 2 230, then air inward into the air cylinder 2 166.

The air piston ring 2 180, fitting around the air piston 2 178, within the air cylinder 2 166. The air piston ring 2 180, fitting around the air piston 2 178, stopping air movement from leaving the air cylinder chamber 2 168, around the air piston 2 178.

### Air Piston 1 172

The air piston 1 172, utilizing member including
the air piston ring 1 174,
the air piston side 1 176.

The air piston 1 172 has, the piston arm 1 148, the air piston ring 1 174, the air piston side 1 176.

The air piston 1 172, used for the movement of air in the air cylinder chamber 1 162. The air cylinder chamber 1 162, used for fore and aft movement of air by the air piston 1 172.

The air piston side 1 176, of the air piston 1 172, on the outward stroke pushes air within the air cylinder chamber 1 162, air toward the air outline inlet 1 186, pushing the air outward into the air outline inlet 1 186, than air outward into the air outline 1 184.

The air piston side 1 176, of the air piston 1 172, on the inward stroke drawing air inward into the air cylinder chamber 1 162, drawing air inward though the air inline outlet 1 216, air inward coming from the air inline 1 212.

The air piston 1 172 on the outward stroke, within the air cylinder 1 160, air pushed from the air cylinder chamber 1 162, air outward into the air outline inlet 1 186.

The air piston 1 172 on the inward stroke, within the air cylinder 1 160, used for movement of air drawn from the air inline outlet 1 216, drawing air inward into the air cylinder chamber 1 162.

The piston arm 1 148 moves, the air piston 1 172 to move for and aft, within the movements of the piston 138. The piston side attached 1 150, attaching the piston 138, the piston arm 1 148 together. The air piston attached 1 152, attaching the piston arm 1 148, the air piston 1 172 together.

The air piston 1 172 move fore and aft, within the air cylinder 1 160. The air piston 1 172, resulting in the air movement, from fore and aft movement of the air piston 1 172.

The air piston 1 172, moves outward toward the flywheel 240, compressing outgoing air, pushing the air movement outward into the air outline inlet 1 186, than air outward into the air outline 1 184. The compressed air from the air outline 1 184, air outward than air enters the air outline outlet 1 188, than air outward onto the flywheel vane 244, rotating the flywheel 240 in a rotary motion.

The air piston 1 172, on the inward stroke move away from the flywheel vane 244, attached to the flywheel 240. The air piston 1 172, compressing the incoming air on the inward stroke though the air inline inlet 1 214, air moves inward though the air inline 1 212, than air moves inward though the air inline outlet 1 216, drawing the air inward into the air cylinder chamber 1 162.

The air piston ring 1 174, fitting around the air piston 1 172. The air piston ring 1 174, fitting around the air piston 1 172, stopping air movement from leaving the air cylinder 1 160, around the air piston 1 172.

### Air Piston 2 178

The air piston 2 178, utilizing member including
the air piston ring 2 180,
the air piston side 2 182.

The air piston 2 178 has, the piston arm 2 154, the air piston ring 2 180, the air piston side 2 182.

Th air piston 2 178, used for the movement of air in the air cylinder chamber 2 168. The air cylinder chamber 2 168, used for for and aft movement of air by the air piston 2 178.

The air piston side 2 182, of the air piston 2 178, on the outward stroke pushes air within the air cylinder chamber 2 168, air toward the air outline inlet 2 200, pushing the air outward into the air outline inlet 2 200, than air outward into the air outline 2 198.

The air piston side 2 182, of the air piston 2 178, on the inward stroke drawing air inward into the air cylinder chamber 2 168, drawing air inward though the air inline outlet 2 230, air inward coming from the air inline 2 226.

The air piston 2 178 on the outward stroke, within the air cylinder 2 166, air pushed from the air cylinder chamber 2 168, air outward into the air outline inlet 2 200.

The air piston 2 178 on the inward stroke, within the air cylinder 2 166, used for movement of air drawn from the air inline outlet 2 230, drawing air inward into the air cylinder chamber 2 168.

The piston arm 2 154 moves, the air piston 2 178 to move fore and aft, within the movements of the piston 138. The piston side attached 2 156, attaching the piston 138, the piston arm 2 154 together. The air piston attached 2 158, attaching the piston arm 2 154, the air piston 2 178 together.

The air piston 2 178 move fore and aft, within the air cylinder 2 166. The air piston 2 178, resulting in the air movement, from fore and aft movement of the air piston 2 178.

The air piston 2 178, moves outward toward the flywheel 240, compressing outgoing air, pushing the air movement outward into the air outline inlet 2 200, than air outward into the air outline 2 198. The compressed air from the air outline 2 198, air outward than air enters the air outline outlet 2 202, than air outward onto the flywheel vane 244, rotating the flywheel 240 in a rotary motion.

The air piston 2 178, on the inward stroke move away from the flywheel vane 244, attached to the flywheel 240. The air piston 2 178, compressing the incoming air on the inward stroke though the air inline inlet 2 228, air moves inward though the air inline 2 226, than air moves inward though the air inline outlet 2 230, drawing the air inward into the air cylinder chamber 2 168.

The air piston ring 2 180, fitting around the air piston 2 178. The air piston ring 2 180, fitting around the air piston 2 178, stopping air movement from leaving the air cylinder 2 166, around the air piston 2 178.

### Air Outline 1 184

The air outline 1 184, utilizing member including
the air outline inlet 1 186,
the air outline outlet 1 188,
the air outline chamber 1 190,
the air outline door 1 192,
the air outline hinge 1 194,
the air outline door vane 1 196.

The air outline 1 184 housing, the air outline chamber 1 190, the air outline door 1 192, the air outline hinge 1 194, the air outline door vane 1 196. The air outline 1 184 has, the air outline inlet 1 186, the air outline outlet 1 188.

The air outline 1 184, being a pipe used for conveying the air from the air cylinder chamber 1 162, air outward onto the flywheel vane 244. The air outline 1 184, used for movement of air from the air cylinder chamber 1 162, air outward onto the flywheel vane 244. The air piston 1 172 on the outward stroke, air within the air cylinder chamber 1 162, air pushed outward into the air outline inlet 1 186, than air pushed outward into the air outline 1 184. Air from the air outline 1 184, air is pushed outward into the air outline outlet 1 188, than air outward onto the flywheel vane 244, rotating the flywheel 240 in a rotary motion.

The air outline 1 184 air movement outward, passes though onto the flywheel van 244, air from the air cylinder 1 160. The air piston 1 172, compressing the outgoing air on the outward stroke though the air outline inlet 1 186. Air movement outward of the compressed air from the air cylinder 1 160, outward air enters the air outlin inlet 1 186, than air outward enters the air outline 1 184. Outward air movement from the air outline 1 184, air outward enters the air outline outlet 1 188, then air outward onto the flywheel vane 244.

The air outline chamber 1 190, a open area within the air outline 1 184. The air outline chamber 1 190, a open area used for opening and closing, the air outline door 1 192.

The air outline hinge 1 194, used for attaching the air outline door 1 192, onto the air outline 1 184. The air outline hinge 1 194, used for opening and closing the air outline door 1 192.

The air outline door 1 192 as closed, used for stopping air movement in the air outline 1 184. The air outline door 1 192 as closed, stopping air from entering the air outline 1 184.

The air outline door 1 192 as open, used for letting air movement though the air outline 1 184. The air outline door 1 192 as open, letting air movement to enter the air outline 1 184. The air outline door 1 192 as open, letting air movement to leave the air outline 1 184, air outward onto the flywheel vane 244.

The air outline door vane 1 196, attached to end of the air outline door 1 192. The air outline door vane 1 196, used for air movement inward moving onto and closing the air outline door 1 192.

### Air Outline Door 1 192

The air outline door 1 192, utilizing member including
the air outline hinge 1 194,
the air outline door vane 1 196.

The air outline door 1 192 has, the air outline hinge 1 194, the air outline door vane 1 196.

The air outline chamber 1 190, the air outline door 1 192, th air outline hinge 1 194, the air outline door vane 1 196, house within the air outline 1 184.

The air outline door 1 192 as open, used for letting movement of air though the air outline 1 184, air outward onto the flywheel vane 244, air from the air cylinder chamber 1 162. The air outline door 1 192 as closed, used for stopping movement of air though the air outline 1 184.

The air outline chamber 1 190, a open area within the air outline 1 184. The air outline chamber 1 190, a open area used for opening and closing, the air outline door 1 192. The air outline 1 184 air movement outward, passes though onto the flywheel vane 244, air from the air cylinder 1 160.

The air outline door 1 192 as closed, used for stopping air movement in the air outline 1 184. The air outline door 1 192 as closed, stopping air from entering the air outline 1 184.

The air outline door 1 192 as open, used for letting air movement though the air outline 1 184. The air outline door 1 192 as open, letting air movement to enter the air outline 1 184. The air outline door 1 192 as open, letting air movement to leave the air outline 1 184, air movement outward onto the flywheel vane 244.

The air piston 1 172 on the outward stroke, air from the air cylinder chamber 1 162, air pushed outward into the air outline inlet 1 186, air outward into the air outline 1 184, than air outward onto the air outline door 1 192, pushing the air outline door 1 192 open.

The air outline door vane 1 196, attached to end of the air outline door 1 192. The air piston 1 172 on the inward stroke, air drawn off the flywheel vane 244, air drawn into the air outline outlet 1 188, than air drawn inward into the air outline 1 184, drawing air inward onto the air outline door vane 1 196, pulling on and closing the air outline door 1 192.

The air outline hinge 1 194, used for attaching the air outline door 1 192, onto the air outline 1 184. The air outline hinge 1 194, used for opening and closing the air outline door 1 192.

### Air Outline 2 198

The air outline 2 198, utilizing member including
the air outline inlet 2 200,
the air outline outlet 2 202,
the air outline chamber 2 204,
the air outline door 2 206,
the air outline hinge 2 208,
the air outline door vane 2 210.

The air outline 2 198 housing, the air outline chamber 2 204, the air outline door 2 206, the air outline hinge 2 208, the air outline door vane 2 210. The air outline 2 198 has, the air outline inlet 2 200, the air outline outlet 2 202.

The air outline 2 198, being a pipe used for conveying the air from the air cylinder chamber 2 168, air outward onto the flywheel vane 244. The air outline 2 198, used for movement of air from the air cylinder chamber 2 168, air outward onto the flywheel vane 244. The air piston 2 178 on the outward stroke, air within the air cylinder chamber 2 168, air pushed outward into the air outline inlet 2 200, than air pushed outward into the air outline 2 198. Air from the air outline 2 198, air is pushed outward into the air outline outlet 2 202, than air outward onto the flywheel vane 244, rotating the flywheel 240 in a rotary motion.

The air outline 2 198 air movement outward, passes though onto the flywheel vane 244, air from the air cylinder 2 166.

The air piston 2 178, compressing the outgoing air on the outward stroke though the air outline inlet 2 200. Air movement outward of the compressed air from the air cylinder 2 166, outward air enters the air outline inlet 2 200, than air outward enters the air outline 2 198. Outward air movement from the air outline 2 198, air outward enters the air outline outlet 2 202, then air outward onto the flywheel vane 244.

The air outline chamber 2 204, a open area within the air outline 2 198. The air outline chamber 2 204, a open area used for opening and closing, the air outline door 2 206.

The air outline hinge 2 208, used for attaching the air outline door 2 206, onto the air outline 2 198. The air outline hinge 2 208, used for opening and closing the air outline door 2 206.

The air outline door 2 206 as closed, used for stopping air movement in the air outline 2 198. The air outline door 2 206 as closed, stopping air from entering the air outline 2 198.

The air outline door 2 206 as open, used for letting air movement though the air outline 2 198. The air outline door 2 206 as open, letting air movement to enter the air outline 2 198. The air outline door 2 206 as open, letting air movement to leave the air outline 2 198, air outward onto the flywheel vane 244.

The air outline door vane 2 210, attached to end of the air outline door 2 206. The air outline door vane 2 210, used for air movement inward moving onto and closing the air outline door 2 206.

### Air Outline Door 2 206

The air outline door 2 206, utilizing member including
the air outline hinge 2 208,
the air outline door vane 2 210.

The air outline door 2 206 has, the air outline hinge 2 208, the air outline door vane 2 210.

The air outline chamber 2 204, the air outline door 2 206, the air outline hinge 2 208, the air outline door vane 2 210, house-within the air outline 2 198.

The air outline door 2 206 as open, used for letting movement of air though the air outline 2 198, air outward onto the flywheel vane 244, air from the air cylinder chamber 2 168. The air outline door 2 206 as closed, used for stopping movement of air though the air outline 2 198.

The air outline chamber 2 204, a open are a within the air outline 2 198. The air outline chamber 2 204, a open are a used for opening and closing, the air outline door 2 206. The air outline 2 198 air movement outward, passes though onto the flywheel vane 244, air from the air cylinder 2 166.

The air outline door 2 206 as closed, used for stopping air movement in the air outline 2 198. The air outline door 2 206 as closed, stopping air from entering the air outline 2 198.

The air outline door 2 206, used for letting air movement though the air outline 2 198 as open. The air outline door 2 206 as open, letting air movement to enter the air outline 2 198. The air outline door 2 206 as open, letting air movement to leave the air outline 2 198, air movement outward onto the flywheel vane 244.

The air piston 2 178 on the outward stroke, air from the air cylinder chamber 2 168, air outward pushed into the air outline inlet 2 200, air outward into the air outline 2 198, than air outward onto the air outline door 2 206, pushing the air outline door 2 206 open.

The air outline door vane 2 210, attached to end of the air outline door 2 206. The air piston 2 178 on the inward stroke, air drawn off the flywheel vane 244, air drawn into the air outline outlet 2 202, than air drawn inward into the air outline 2 198, drawing air inward into the air outline door vane 2 210, pulling on and closing the air outline door 2 206.

The air outline hinge 2 208, used for attaching the air outline door 2 206, onto the air outline 2 198. The air outline hinge 2 208, used for opening and closing the air outline door 2 206.

### Air Inline 1 212

The air inline 1 212, utilizing member including
the air inline inlet 1 214,
the air inline outlet 1 216,
the air inline chamber 1 218,
the air inline door 1 220,
the air inline hinge 1 222,
the air inline door van 1 224.

The air inline 1 212 housing, the air inline chamber 1 218, the air inline hinge 1 222, the air inline door 1 220, the air inline door vane 1 224. The air inline 1 212 has, the air inline inlet 1 214, the air inline outlet 1 216.

The air inline 1 212, being a pipe used for conveying the air from the flywheel vane 244, air inward into the air cylinder chamber 1 162. The air inline 1 212, used for movement of air from the flywheel vane 244, air inward into the air cylinder chamber 1 162. The air piston 1 172 on the inward stroke, air drawn off the flywheel vane 244, than air drawn into the air inline inlet 1 214, than air drawn into the air inline 1 212. Air from the air inline 1 212, air drawn into the air inline outlet 1 216, than air drawn into the air cylinder chamber 1 162.

The air inline 1 212 air movement inward, passes from the flywheel vane 244, air inward into the air cylinder 1 160.

The air piston 1 172, compressing the incoming air on the inward stroke though the air inline inlet 1 214, air moves inward though the air inline 1 212, air moves inward though the air inline outlet 1 216, drawing the air inward into the air cylinder chamber 1 162. Inward air movement from the flywheel vane 244, air movement inward being compressed enters the air inline inlet 1 214. Inward air movement from the air inline 1 212, than air drawn into the air inline outlet 1 216, then air drawn into the air cylinder 1 160. Inward air movement of the compressed air drawn and pulls the flywheel 240 in a rotary motion.

The air inline chamber 1 218, a open area used for opening and closing, the air inline door 1 220.

The air inline hinge 1 222, used for attaching the air inline door 1 220, onto the air inline 1 212. The air inline hinge 1 222, used for opening and closing the air inline door 1 220.

The air inline door 1 220 as closed, used for stopping air movement in the air inline 1 212. The air inline door 1 220 as closed, stopping air from entering the air inline 1 212.

The air inline door 1 220 as open, used for letting air movement though the air inline 1 212. The air inline door 1 220 as open, letting air movement to enter the air inline 1 212. The air inline door 1 220 as open, letting air movement to leave the air inline 1 212, air inward into the air cylinder 1 160.

The air inline door vane 1 224, attached to end of the air inline door 1 220. The air inline door vane 1 224, used for air movement outward moving onto and closing the air inline door 1 220.

### Air Inline Door 1 220

The air inline door 1 220, utilizing member including
the air inline hinge 1 222,
the air inline door vane 1 224.

The air inline door 1 220 has, the air inline hinge 1 222, the air inline door vane 1 224.

The air inline chamber 1 218, the air inline door 1 220, the air inline hinge 1 222, the air inline door vane 1 224, house within the air inline 1 212.

The air inline chamber 1 218, a open area within the air inline 1 212. The air inline chamber 1 218, a open area used for opening and closing, the air inline door 1 220. The air inline 1 212 air movement inward, passes though from the flywheel vane 244, air inward into the air cylinder chamber 1 162.

The air inline door 1 220 as closed, used for stopping air movement in the air inline 1 212. The air inline door 1 220 as closed, stopping air from entering the air inline 1 212.

The air inline door 1 220 as open, used for letting air movement though the air inline 1 212. The air inline door 1 220 as open, letting air movement to enter the air inline 1 212. The air inline door 1 220 as open, letting air movement to leave the air inline 1 212, air movement onto the flywheel vane 244.

The air piston 1 172 on the inward stroke, air drawn into the air cylinder chamber 1 162, air drawn from the air inline outlet 1 216, air draw from the air inline 1 212, air pulling and drawing the air inline door 1 220 open.

The air inline door vane 1 224, attached to end of the air inline door 1 220. The air piston 1 172 on the outward stroke, air drawn into the air inline outlet 1 216, air drawn into the air inline 1 212, than air drawn onto the air inline door vane 1 224, drawing on and closing the air inline door 1 220.

The air inline hinge 1 222, used for attaching the air inline door 1 220, onto the air inline 1 212. The air inline hinge 1 222, used for opening and closing the air inline door 1 220.

### Air Inline 2 226

The air inline 2 226, utilizing member including
the air inline inlet 2 228,
the air inline outlet 2 230,
the air inline chamber 2 232,
the air inline door 2 234,
the air inline hinge 2 236,
the air inline door vane 2 238.

The air inline 2 226 housing, the air inline chamber 2 232, the air inline hinge 2 236, the air inline door 2 234, the air inline door vane 2 238. The air inline 2 226 has, the air inline inlet 2 228, the air inline outlet 2 230.

The air inline 2 226, being a pipe used for conveying the air from the flywheel vane 244, air inward into the air cylinder chamber 2 168. The air inline 2 226, used for movement of air from the flywheel vane 244, air inward into the air cylinder chamber 2 168. The air piston 2 178 on the inward stroke, air drawn off the flywheel vane 244, than air drawn into the air inline inlet 2 228, than air drawn into the air inline 2 226. Air from the air inline 2 226, air drawn into the air inline outlet 2 230, than air drawn into the air cylinder chamber 2 168.

The air inline 2 226 air movement inward, passes from the flywheel vane 244, air inward into the air cylinder 2 166.

The air piston 2 178, compressing the incoming air on the inward stroke though the air inline inlet 2 228, air moves, inward though the air inline 2 226, air moves inward though the air inline outlet 2 230, drawing the air inward into the air cylinder chamber 2 168. Inward air movement from the flywheel vane 244, air movement inward being compressed enters the air inline inlet 2 228. Inward air movement from the air inline 2 226, than air drawn into the air inline outlet 2 230, then air drawn into the air cylinder 2 166. Inward air movement of the compressed air drawn and pulls the flywheel 240 in a rotary motion.

The air inline chamber 2 232, a open area used for opening and closing, the air inline door 2 234.

The air inline hinge 2 236, used for attaching the air inline door 2 234, onto the air inline 2 226. The air inline hinge 2 236, used for opening and closing the air inline door 2 234.

The air inline door 2 234 as closed, used for stopping air movement in the air inline 2 226. The air inline door 2 234 as closed, stopping air from entering the air inline 2 226.

The air inline door 2 234 as open, used for letting air movement though the air inline 2 226. The air inline door 2 234 as open, letting air movement to enter the air inline 2 226. The air inline door 2 234 as open, letting air movement to leave the air inline 2 226, air inward into the air cylinder 2 166.

The air inline door vane 2 238, attached to end of the air inline door 2 234. The air inline door vane 2 238, used for air movement outward moving onto and closing the air inline door 2 234.

### Air Inline Door 2 234

The air inline door 2 234, utilizing member including
the air inline hinge 2 236,
the air inline door vane 2 238.

The air inline door 2 234 has, the air inline hinge 2 236, the air inline door vane 2 238.

The air inline chamber 2 232, the air inline door 2 234, the air inline hinge 2 236, the air inline door vane 2 238, house within the air inline 2 226.

The air inline chamber 2 232, a open area within the air inline 2 226. The air inline chamber 2 232, a open area used for opening and closing, the air inline door 2 234. The air inline 2 226 air movement inward, passes though from the flywheel vane 244, air inward into the air cylinder chamber 2 168.

The air inline door 2 234 as closed, used for stopping air movement in the air inline 2 226. The air inline door 2 234 as closed, stopping air from entering the air inline 2 226.

The air inline door 2 234 as open, used for letting air movement though the air inlin~e 2 226. The air inline door 2 234 as open, letting air movement to enter the air inline 2 226. The air inline door 2 234 as open, letting air movement to leave the,air inline 2 226, air movement onto the flywheel vane 244.

The air piston 2 178 on the inward stroke, air drawn into the air cylinder chamber 2 168, air drawn from the air inline outlet 2 230, air drawn from the air inline 2 226, air pulling and drawing the air inline door 2 234 open.

The air inline door vane 2 238, attached to end of the air inline door 2 234. The air piston 2 178 on the outward stroke, air drawn into the air inline outlet 2 230, air drawn into the air inline 2 226, than air drawn onto the air inline door van 2 238, drawing on and closing the air inline door 2 234.

The air inline hinge 2 236, used for attaching the air inline door 2 234, onto the air inline 2 226. The air inline hinge 2 236, used for opening and closing the air inline door 2 234.

### Flywheel 240

The flywheel 240, utilizing member including
a flywheel outer edge 242,
the flywheel vane 244.

The flywheel 240, has the flywheel outer edge 242, the flywheel vane 244, the drive shaft 246.

The flywheel 240, used for providing the power for driving the drive shaft 246. The flywheel vane 244, used for providing the power for driving the flywheel 240.

The flywheel 240, having the flywheel vane 244 attached. The flywheel vane 244 attached to the flywheel outer edge 242, of the flywheel 240.

The air piston 1 172, moves outward toward the flywheel 240, compressing outgoing air, pushing the air movement outward into the air outline inlet 1 186, than air outward into the air outline 1 184. The compressed air from the air outline 1 184, than air outward enters the air outline outlet 1 188, than air pushes outward onto the flywheel vane 244, rotating the flywheel 240 in a rotary motion.

The air piston 2 178, moves outward toward the flywheel 240, compressing outgoing air, pushing the air movement outward into the air outline inlet 2 200, than air outward into the air outline 2 198. The compressed air from the air outline 2 198, than air outward enters the air outline outlet 2 202, than air pushes outward onto the flywheel vane 244, attached to the flywheel 240, rotating the flywheel 240 in a rotary motion.

The air piston 1 172, on the inward stroke move away from the flywheel vane 244, attached to the flywheel 240. The air piston 1 172 within, the air cylinder 1 160, draws air movement inward, by using the air piston 1 172, drawing air off the flywheel van 244, drawing air inward into the air inline inlet 1 214, than air inward into the air inline 1 212, than air inward into the air inline outlet 1 216, then air inward into the air cylinder 1 160. The flywheel vane 244, is drawn forward by the air being drawn off and into the air inline inlet 1 214.

The air piston 2 178, on the inward stroke move away from the flywheel vane 244, attached to the flywheel 240. The air piston 2 178 within, the air cylinder 2 166, draws air movement inward, by using the air piston 2 178, drawing air off the flywheel vane 244, drawing air inward into the air inline inlet 2 228, than air inward into the air inline 2 226, than air inward into the air inline outlet 2 230, then air inward into the air cylinder 2 166. The flywheel vane 244, is drawn forward by the air being drawn off and into the air inline inlet 2 228.

The drive shaft 246, attached to the flywheel 240. The drive shaft 246 moves within the rotary motion of the flywheel 240.

### Drive Shaft 246

The drive shaft 246, utilizing the drive shaft 246, attached to the center of the flywheel 240.

The drive shaft 246, has the flywheel 240, the flywheel vane 244. The flywheel vane 244, mounted along the flywheel outer edge 242, of the flywheel 240. The flywheel vane 244 is driven and drawn forward by the use of air in a rotary motion.

The drive shaft 246 moves within the rotary motion of the flywheel 240. The drive shaft 246 is driven from the continuous rotation of the flywheel 240. The drive shaft 246 in the center of the flywheel 240.

Using compressed air movement to push air onto, on the outward stroke and drawn air in from the inward stroke, onto and from the flywheel vane 244, moving the flywheel 240 attached in a rotary motion. The flywheel 240, attached to the drive shaft 246, rotating the drive shaft 246 in a rotary motion, converting energy into mechanical energy or work.

### Objects and Advantages

The engine 110 utilization innovations which improve controllability and efficiency of the free-piston engine combining with the flywheel 240. Advantages of a free-piston engine that its piston not being rigidly attached to the drive shaft 246 connected by a rod. Using the cylinder 112 housing, the combustion chambers 1 118 and the combustion chambers 2 128, with the piston 138. Advantageous application using, the cylinder 112 with, the combustion chamber 1 118 and the combustion chambers 2 128, with the piston 138 within freely moving fore and aft, from the combustion chamber 1 118 to the combustion chamber 2 128.

Advantageous application using, the piston 138 along with, the piston arm 1 148 and the piston arm 2 154, attached and extended out though the arm opening 1 114 and extended out though the arm opening 2 116 each side of the cylinder. By using compressed air in using, the air cylinder 1 160 and the air cylinder 2 166, the air cylinder chamber 1 162 and the air cylinder chamber 2 168, the air piston 1 172 and the air piston 2 178. Pushing air outward onto and drawing air inward off the flywheel vane, attached to the flywheel. Rotating the flywheel in a rotary motion.

This will reduce toxic emissions, weight and size of such engines. Increases energy efficiency by increasing the specific power output, resulting in a smaller engine with less heat and friction losses.

Further objects and advantages of my invention will become apparent. This consideration of the drawing and ensuring description will become apparent.

### BRIEF DESCRIPTION OF THE DRAWING

This invention relates to apparatus and methods.

FIG. 1 is a perspective view of Flywheel Vane Combustion Engine. This is in accordance with principles of the present invention.

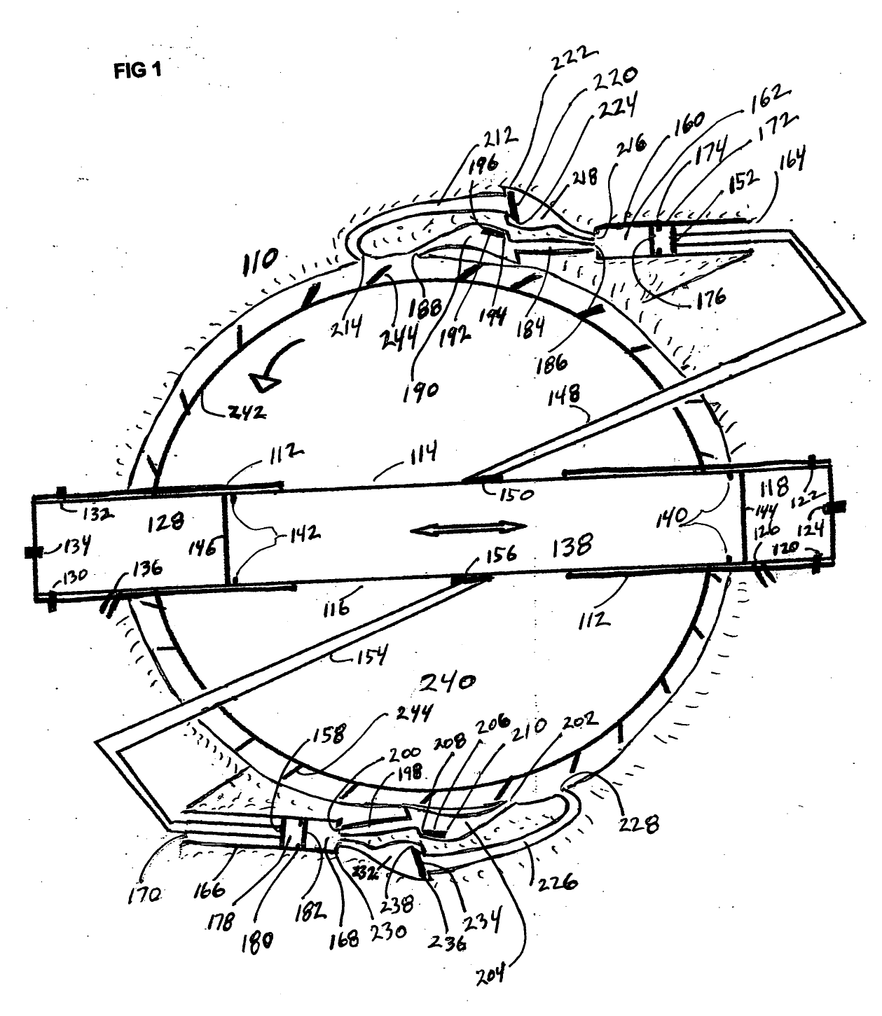

### Reference Numerals in Drawings

110 engine
112 cylinder
114 arm opening 1
116 arm opening 2
118 combustion chamber 1
120 sensor 1
122 injector 1
124 spark plug 1
126 exhaust outlet 1
128 combustion chamber 2
130 sensor 2
132 injector 2
134 spark plug 2
136 exhaust outlet 2
138 piston
140 piston ring 1
142 piston ring 2
144 piston side 1
146 piston side 2
148 piston arm 1
150 piston side attached 1
152 air piston attached 1
154 piston arm 2
156 piston side attached 2
158 air piston attached 2
160 air cylinder 1
162 air cylinder chamber 1
164 air cylinder opening 1
166 air cylinder 2
168 air cylinder chamber 2
170 air cylinder opening 2
172 air piston 1
174 air piston ring 1
176 air piston side 1
178 air piston 2
180 air piston ring 2
182 air piston side 2
184 air outline 1
186 air outline inlet 1
188 air outline outlet 1
190 air outline chamber 1
192 air outline door 1
194 air outline hinge 1
196 air outline door vane 1
198 air outline 2
200 air outline inlet 2
202 air outline outlet 2
204 air outline chamber 2
206 air outline door 2
208 air outline hinge 2
210 air outline door vane 2
212 air inline 1
214 air inline inlet 1
216 air inline outlet I
218 air inline chamber 1
220 air inline door I
222 air inline hinge 1
224 air inline door vane 1
226 air inline 2
228 air inline inlet 2
230 air inline outlet 2
232 air inline chamber 2
234 air inline door 2
236 air inline hinge 2
238 air inline door vane 2
240 flywheel
242 flywheel outer edge
244 flywheel vane
246 drive shaft

### Ramifications of Detailed Description

The foregoing discussion and claims that follow describe only preferred embodiments of present invention. These embodiments particularly with respect to the claims. Understood a number of changes might be made without departing from essence present invention. It is intended that such changes substantially achieve the same results. Substantially same way will still fall within scope of the present invention.

It is not practical to describe in claims all possible embodiments. Embodiments may be accomplished generally in keeping with present invention. Disclosure may include separately or collectively aspects described found throughout description of patent. While these may be added to explicitly include such details. Existing claims should be construed to encompass such aspects. To the extent methods claimed in present invention are not further discussed. Any extent methods are natural outgrowths of the system or apparatus claims. Therefore, separate and further discussions of the methods are deemed unnecessary. Otherwise claim steps implicit in use and manufacture of system or apparatus claims.

Furthermore, steps organized in logical fashion and other sequences can and do occur. Therefore, method claims should not be construed to include only this order. Other order and sequence steps may be presented.

Furthermore, any references mentioned in the application for this patent as well as all references Listed. That all and any information disclosure originally filed with the application is hereby incorporated. That all reference in their entirety to the extent such may be deemed essential. That all supports empoblement of the invention(s). However, to the eext entestatements might be considered inconsistent with the patenting of this/these invention(s). Any such statements are expressly not to be considered as made by the applicant. Notice: Subject to any disclaimer, the term of this patent is extended or adjusted under 35 U.S.C. 154(b) by 0 days. e claims I claim: 1. A engine comprising in combination: A. a cylinder, a portion defining a arm opening 1; a portion defining a arm opening 2; B. a combustion chamber 1, a portion defining a sensor 1, a portion defining a injector 1, a portion defining a spark plug 1, a portion defining a exhaust outlet 1; C. a combustion chamber 2, a portion defining a sensor 2, a portion defining a-injector 2, a portion defining a spark plug 2, a portion defining a exhaust outlet 2; D. a piston, a portion defining a piston ring 1, a portion defining a piston ring 2, a portion defining a piston side 1, a portion defining a piston side 2; E. a piston arm 1, a portion defining a piston side attached 1, a portion defining a air piston attached 1; F. a piston arm 2, a portion defining a piston side attached 2, a portion defining a air piston attached 2; G. a air cylirider 1, a portion defining a air cylinder chamber 1, a portion defining a air cylinder opening 1; H. a air cylinder 2, a portion defining a air cylinder chamber 2, a portion defining a air cylinder opening 2; I. a air piston 1, a portion defining a air piston ring 1, a portion defining a air piston side 1; J. a air piston 2, a portion defining a air piston ring 2, a portion defining a air piston side 2; K. a air outline 1, a portion defining a air outline inlet 1, a portion defining a air outline outlet 1, a portion d fining a air outline chamber 1; L. a air outline door 1, a portion defining a air outline

1. A engine comprising in combination:
A. a cylinder, a portion defining a arm opening 1; a portion defining a arm opening 2;
B. a combustion chamber 1, a portion defining a sensor 1, a portion defining a injector 1, a portion defining a spark plug 1, a portion defining a exhaust outlet 1;
C. a combustion chamber 2, a portion defining a sensor 2, a portion defining a injector 2, a portion defining a spark plug 2, a portion defining a exhaust outlet 2;
D. a piston, a portion defining a piston ring 1, a portion defining a piston ring 2, a portion defining a piston side 1, a portion defining a piston side 2;
E. a piston arm 1, a portion defining a piston side attached 1, a portion defining a air piston attached 1;
F. a piston arm 2, a portion defining a piston side attached 2, a portion defining a air piston attached 2;
G. a air cylinder 1, a portion defining a air cylinder chamber 1, a portion defining a air cylinder opening 1;
H. a air cylinder 2, a portion defining a air cylinder chamber 2, a portion defining a air cylinder opening 2;
I. a air piston 1, a portion defining a air piston ring 1, a portion defining a air piston side 1;
J. a air piston 2, a portion defining a air piston ring 2, a portion defining a air piston side 2;
K. a air outline 1, a portion defining a air outline inlet 1, a portion defining a air outline outlet 1, a portion defining a air outline chamber 1;
L. a air outline door 1, a portion defining a air outline hinge 1, a portion defining a air outline door vane 1;
M. a air outline 2, a portion defining a air outline inlet 2, a portion defining a air outline outlet 2, a portion defining a air outline chamber 2;
N. a air outline door 2, a portion defining a air outline hinge 2, a portion defining a air outline door vane 2;
O. a air inline 1, a portion defining a air inline inlet 1, a portion defining a air inline outlet 1, a portion defining a air inline chamber 1;
P. a air inline door 1, a portion defining a air inline hinge 1, a portion defining a air inline door vane 1;
Q. a air inline 2, a portion defining a air inline inlet 2, a portion defining a air inline outlet 2, a portion defining a air inline chamber 2;
R. a air inline door 2, a portion defining a air inline hinge 2, a portion defining a air inline door vane 2;
S. a flywheel, a portion defining a flywheel outer edge;
T. a flywheel vane;
U. a drive shaft.

2. Engine according to claim 1, wherein said engine includes, said cylinder;

3. Engine according to claim 1, wherein said engine includes, said arm opening 1;

4. Engine according to claim 1, wherein said engine includes, said arm opening 2;

5. Engine according to claim 1, wherein said engine includes, said combustion chamber 1;

6. Engine according to claim 1, wherein said engine includes, said sensor 1;

7. Engine according to claim 1, wherein said engine includes, said injector 1;

8. Engine according to claim 1, wherein said engine includes, said spark plug 1;

9. Engine according to claim 1, wherein said engine includes, said exhaust outlet 1;

10. Engine according to claim 1, wherein said engine includes, said combustion chamber 2;

11. Engine according to claim 1, wherein said engine includes, said sensor 2;

13. Engine according to claim 1, wherein said engine includes, said injector 2;

14. Engine according to claim 1, wherein said engine includes, said spark plug 2;

15. Engine according to claim 1, wherein said engine includes, said exhaust outlet 2;

16. Engine according to claim 1, wherein said engine includes, said piston;

17. Engine according to claim 1, wherein said engine includes, said piston ring 1;

18. Engine according to claim 1, wherein said engine includes, said piston ring 2;

19. Engine according to claim 1, wherein said engine includes, said piston side 1;

20. Engine according to claim 1, wherein said engine includes, said piston side 2;

21. Engine according to claim 1, wherein said engine includes, said piston arm 1;

22. Engine according to claim 1, wherein said engine includes, said piston side attached 1;

23. Engine according to claim 1, wherein said engine includes, said air piston attached 1;

24. Engine according to claim 1, wherein said engine includes, said piston arm 2;

25. Engine according to claim 1, wherein said engine includes, said piston side attached 2;

26. Engine according to claim 1, wherein said engine includes, said air piston attached 2;

27. Engine according to claim 1, wherein said engine includes, said air cylinder 1;

28. Engine according to claim 1, wherein said engine includes, said air cylinder chamber 1;

29. Engine according to claim 1, wherein said engine includes, said air cylinder opening 1;

30. Engine according to claim 1, wherein said engine includes, said air cylinder 2;

31. Engine according to claim 1, wherein said engine includes, said air cylinder chamber 2;

32. Engine according to claim 1, wherein said engine includes, said air cylinder opening 2;

33. Engine according to claim 1, wherein said engine includes, said air piston 1;

34. Engine according to claim 1, wherein said engine includes, said air piston ring 1;

35. Engine according to claim 1, wherein said engine includes, said air piston side 1;

36. Engine according to claim 1, wherein said engine includes, said air piston 2;

37. Engine according to claim 1, wherein said engine includes, said air piston ring 2;

38. Engine according to claim 1, wherein said engine includes, said air piston side 2;

39. Engine according to claim 1, wherein said engine includes, said air outline 1;

40. Engine according to claim 1, wherein said engine includes, said air outline inlet 1;

41. Engine according to claim 1, wherein said engine includes, said air outline outlet 1;

42. Engine according to claim 1, wherein said engine includes, said air outline chamber 1;

43. Engine according to claim 1, wherein said engine includes, said air outline door 1;

44. Engine according to claim 1, wherein said engine includes, said air outline hinge 1;

45. Engine according to claim 1, wherein said engine includes, said air outline door vane 1;

46. Engine according to claim 1, wherein said engine includes, said air outline 2;

47. Engine according to claim 1, wherein said engine includes, said air outline inlet 2;

48. Engine according to claim 1, wherein said engine includes, said air outline outlet 2;

49. Engine according to claim 1, wherein said engine includes, said air outline chamber 2;

50. Engine according to claim 1, wherein said engine includes, said air outline door 2;

51. Engine according to claim 1, wherein said engine includes, said air outline hinge 2;

52. Engine according to claim 1, wherein said engine includes, said air outline door vane 2;

53. Engine according to claim 1, wherein said engine includes, said air inline 1;

54. Engine according to claim 1, wherein said engine includes, said air inline inlet 1;

55. Engine according to claim 1, wherein said engine includes, said air inline outlet 1;

56. Engine according to claim 1, wherein said engine includes, said air inline chamber 1;

57. Engine according to claim 1, wherein said engine includes, said air inline door 1;

58. Engine according to claim 1, wherein said engine includes, said air inline hinge 1;

59. Engine according to claim 1, wherein said engine includes, said air inline door vane 1;

60. Engine according to claim 1, wherein said engine includes, said air inline 2;

61. Engine according to claim 1, wherein said engine includes, said air inline inlet 2;

62. Engine according to claim 1, wherein said engine includes, said air inline outlet 2;

63. Engine according to claim 1, wherein said engine includes, said air inline chamber 2;

64. Engine according to claim 1, wherein said engine includes, said air inline door 2;

65. Engine according to claim 1, wherein said engine includes, said air inline hinge 2;

66. Engine according to claim 1, wherein said engine includes, said air inline door vane 2;

67. Engine according to claim 1, wherein said engine includes, said flywheel;

68. Engine according to claim 1, wherein said engine includes, said flywheel outer edge;

69. Engine according to claim 1, wherein said engine includes, said flywheel vane;

70. Engine according to claim 1, wherein said engine includes, said drive shaft.
